(19) United States
(12) Patent Application Publication
(10) Pub. No.: US 2024/0290310 A1
(43) Pub. Date: Aug. 29, 2024

(54) DEVICE FOR GENERATING A HAPTIC SIMULATION OF A MUSICAL INSTRUMENT

(71) Applicants: Ecole Polytechnique, Palaiseau (FR); Centre National De La Recherche Scientifique, Paris 16 (FR)

(72) Inventors: Xavier Boutillon, Palaiseau Cedex (FR); Vincent De Greef, Palaiseau Cedex (FR); Jérémie Chichignoud, Palaiseau Cedex (FR)

(21) Appl. No.: 18/577,091

(22) PCT Filed: Jul. 5, 2022
(86) PCT No.: PCT/FR2022/051342

§ 371 Date: Jan. 5, 2024

(30) Foreign Application Priority Data
Jul. 7, 2021 (FR) FR2107340

(51) Int. Cl. G10H 1/34

(52) U.S. Cl. CPC G10H 1/346; G10H 2220/221; G10H 2220/311

(57) ABSTRACT

A haptic device for controlling a key of a keyboard with which an electronic musical instrument is equipped, the device being associated with a key mounted so as to be able to pivot with respect to a frame, the key extending in a longitudinal direction and having an angular movement between a high angular position, and a low angular position, wherein the device comprises:—means for detecting the dynamic state of the key,—computing means for computing, depending on the dynamic information, an instantaneous resistive force to be exerted on the key in response to a depression of the key,—a rotary electrical actuator,—mechanical linking means placed between the actuator and the key so as to apply, to the key, the resistive force, comprising at least one element that flexes under pressure and stiffens under traction.

### CROSS REFERENCE TO RELATED APPLICATIONS

This application is a national phase entry under 35 U.S.C. § 371 of International Patent Application PCT/FR2022/051342, filed Jul. 5, 2022, designating the United States of America and published as International Patent Publication WO 2023/281206 A1 on Jan. 12, 2023, which claims the benefit under Article 8 of the Patent Cooperation Treaty to French Patent Application Serial No. FR2107340, filed Jul. 7, 2021.

### TECHNICAL FIELD

The present disclosure relates to devices for haptic simulation or emulation of keyboard-based digital musical instruments.

The present disclosure relates more particularly to a device reproducing the haptic sensation of the keyboards of an acoustic piano by an electronic piano and its associated method.

### BACKGROUND

The designers and manufacturers of electronic pianos have striven for many years to improve the sensation of touch in order to come closer to that of the acoustic piano by providing a haptic effect that approaches the original. On the keys on the keyboard of the electronic piano, it is therefore a matter of reproducing a “force feedback” that the parts (bridge, jack, wippen, hammer, muffler) of the mechanism of acoustic piano keys exert.

Conventional acoustic pianos are designed with a certain resistance to the touch and a certain return speed of the keys, in order to operate correctly and offer a good sensation of play. To tune the piano keyboard, focus is placed on the descending weight of the keys and the ascending weight of the keys, and weights are sometimes attached to best tune these values. The balancing of the feel also depends on the inertia of the mechanics. This depends on the mass of the parts, mainly of the hammer and of the weights, and of the mechanical wippens. More specifically, it can be said that the inertia is dependent on the mechanical ratio between the stroke of the hammer and the stroke of the key. Finally, many other effects, non-linear and sometimes non-regular (in the mathematical sense), also occur in the quality of the feel: stiffness of the connecting felts between parts, internal friction on the felts, dry friction on the contacts and in the axes of rotation. Ultimately, the relationship between the “force feedback” of the key and its movement results from a dynamic range with several degrees of freedom, which is non-linear, non-regular and dependent on the history of movement. It cannot be described correctly by an impedance-type relationship.

Beginning 1928, on Ondes Martenot instruments, it has been possible to find a key, called the “intensity key” or expression key, which makes it possible to control the volume of the sound generated by the instrument. The key is mounted in the form of a lever so that the pressing the key causes the crushing of a bag of conductive powder that transmits the electrical signal carrying the sound. The crushing of the bag leads to a modification of the resistivity of the powder and, consequently, of the amplitude of the sound. The use of such a bag allows a relationship between the force applied to the key and the amplitude of sound that is very close to the psycho-physiological perception by the musician.

Document U.S. Pat. No. 9,275,618 returns to this principle by improving it. The tail of the key is secured to a flexible metal strip at its end, the strip being sandwiched so as to pivot the key. A force and/or position sensor is located on the key. A deformable stop (elastomeric material) located under the tail of the key exerts a force that resists the downward movement applied by the user. An asymmetrical bore in this stop confers a monotonous non-linear character onto the resistive force applied by the stop. The sensor recovers the information of the resistive force resulting from the action of the flexible strip and of the deformable stop, in the form of a signal that is then supplied to a processing unit to generate a sound with a volume corresponding to the stimulus.

The patent application FR2902538 describes a haptic simulation device using a magnetic-rheological fluid whose viscosity is modulated by a magnetic field to generate a force that opposes the movement of the key in order to improve the feeling of the musician. The keyboard musical instrument disclosed in this document uses three sensors (acceleration, speed and position) placed to provide, in real time, a current control to means for generating the magnetic field as a function of time, which will oppose a reaction force that is dependent on the displacement of the key in order to provide a satisfactory sensation of touch. The generating means consist of a coil covered by a current that varies over time, which makes it possible to actuate a force whose intensity, on a strip secured to the key, varies as a function of the value of the current.

The document WO 2020/016536 describes a haptic controller capable of reproducing certain sounds other than a traditional piano, one of these features commonly being designated by the term “aftertouch” and the essential element of which is a damping device consisting of a body made of deformable material having two recesses, the body having a protrusion placed in a groove arranged on a bottom face of a key. The two recesses absorb the compression exerted by the key via the protrusion along two different damping profiles, one flexible, the other rigid. Sensors adapted to measure the rotational and translational displacement of the keys deliver a signal as a function of this displacement.

Document U.S. Pat. No. 7,582,821 discloses a device seeking to reproduce the sensation of releasing a key of an acoustic piano and is essentially composed of a pivot lever, three key switches, and a retractable load member. When the musician pushes a key, the key pivots about its axis and presses on the pivoting lever, which is substantially as long as the key and arranged under the key. The pivoting lever in turn touches three elastic switches of different lengths making it possible to provide information about the depth of pressing, thanks to the successive triggering sequence of the switches. The retractable load member will slow down the ascent of the lever according to the information collected by the switches and the position sensors.

In document US2018286605, the reactive force generation device is composed of a deformable element in the form of an inclined dome having at the peak a flat surface, the inclination of which makes it possible to stably receive the key that exerts the pressure.

Finally, in the document “Réalisation d'un dispositif à retour d'effort pour simuler le toucher de diverses mécaniques de frappe des pianos,” Guillaume Paillot, Quentin Desclée (2018), a force feedback device is proposed, composed of an actuator placed at the action of the key (the contact area between the key and the striking mechanism) and composed of two fixed permanent magnets and a coil integral with the key. This embodiment poses a stability problem due to its mass and inertia that this arrangement confers, which are stronger than that of a traditional key.

However, these devices are bulky for the available space and/or expensive and/or do not make it possible to sufficiently reproduce the dynamics of a given key (for example, of an acoustic piano) actively, without using the mechanism at the origin of this dynamic, which is even more expensive, or a derivative mechanism, which is unsatisfactory with regard to the user's ability to control the musical instrument.

### BRIEF SUMMARY

To this end, and according to a first aspect, the present disclosure proposes a haptic device for controlling a key of a keyboard equipping an electronic musical instrument intended to reproduce the sensation of use of a similar acoustic musical instrument, the device being arranged to be associated with a key of the electronic musical instrument pivotably mounted relative to a frame around a pivot axis, the key extending in a longitudinal direction and having an angular displacement between a high angular position, called the original position, and a low angular position, called a stop.

The device comprises:
detection means for detecting information of the dynamic state of the key,
computing means for computing, as a function of the dynamic information thus detected, an instantaneous resistive force to be exerted on the key in response to the key being depressed,
a rotary electric actuator arranged to produce the resisting force, and
mechanical linking means arranged between the rotary electrical actuator and the key in order to apply to the key the resisting force, the mechanical linking means comprising at least one element that flexes under pressure and stiffens under traction.

The device according to the present disclosure makes it possible to reproduce the sensation of use of an acoustic musical instrument, for example, a piano, while proposing a compact, inexpensive arrangement having little or no inertia in its actuation and little or no instability in its control. It makes it possible to choose or set a resistance to the predetermined key depression. In addition, it makes it possible to exert a dynamic opposition force upon the depression of the key, according to a predetermined dynamic relationship, including implementing several internal degrees of freedom. Finally, it tends to return the key to its original position, when the user stops pressing on the key.

For the foregoing and/or for the rest of the description, the terms below have the definitions as follows:
key: a manual control member arranged to control the emission of a sound when pressed by a musician user,
rotary electric actuator: a rotating electromagnetic device or actuator,
distal end of the key: the pressing zone or the end zone intended to receive the user's finger(s),
proximal end: the end of the key opposite the distal end,
key return: a part protruding from the lower face or bottom face of the key so that one face of the key return is opposite the lower face or bottom face of the key, for example, the key return is “L”-shaped, of which one face of the base of the “L”-shaped key return is opposite the lower face or bottom face of the key,
mechanical linking means: means connecting the actuator to the key, the means being able to comprise one or more interconnected mechanical elements,
flexible element in a single direction of the mechanical linking means: means that can flex without having longitudinal elasticity, and/or limited flexibility (generally a wire has very great flexibility) and especially one-dimensional or unidirectional: zero flexibility in two directions of stress,
element that flexes under pressure and stiffens under traction: a flexible element arranged to work in tension both to convert the resistant mechanical torque into a resistive force applied at a point of the key that is being depressed, and to return the key to its angular rest position,
termination: an end of the mechanical linking means, such as an actuator termination or a key termination, and/or an end of a flexible element, for example, a cable termination or ribbon termination,
high angular position, or original position: the position wherein the key is located, in upper abutment, before a user begins to actuate it to obtain a sound when playing the instrument as usual,
ribbon: an element having a width at least three times greater than its thickness, for example, a thin strip-shaped sheet made of metal or of fiber or composite polymer, able to flex without having longitudinal or transverse elasticity other than that allowing bending or curvature, and having low but not negligible resistance to bending or winding, and
cable: a cable or the parallel combination of multiple cables (for example, between 2 and 5 cables) that can flex in two directions but that do not have longitudinal elasticity.

Preferably, the pivot axis of the key is arranged at a proximal end of the key.

Preferably, the mechanical linking means are arranged between the actuator and the key. The mechanical linking means comprise an actuator termination and a key termination. According to one embodiment, the mechanical linking means comprise a single key termination and a single actuator termination.

Preferably, the key termination is attached to the key at a key point, called the fastening point, located between on the one hand, a receiving point located at a distance at least equal to 25% of the longitudinal length of the key from the pivot axis, and on the other hand, the distal end of the key. In other words, the key point can be located on a continuous area extending over a distance equal to 75% of the longitudinal length of the key from the distal end of the key.

The function of the actuator and mechanical linking means between the actuator and the key consists of physically exerting a force on the key, the force being prescribed or its relationship to the movement of the key is predetermined. Depending on the fastening point on the key, the torque to be exerted by the actuator on the key is, at a maximum, calculated as the product of around twenty newtons times the lever arm of the distal end, at the marking fortissimo.

According to a first embodiment, the rotary electrical actuator has a rotation axis parallel to the pivot axis of the key.

According to a second embodiment, the rotary electrical actuator has a rotation axis parallel to the longitudinal direction of the key.

According to a third embodiment, the rotary electrical actuator has a rotation axis perpendicular to the longitudinal direction of the key and to the rotation axis of the key.

The position where the rotation axis of the actuator is parallel, or perpendicular, to the longitudinal direction of the key, is understood to be a position established when the key is at rest or in the original position, the key being able to pivot by a few degrees when pressed by a user. In other words, the rotation axis of the actuator and the longitudinal direction of the key are substantially parallel or substantially perpendicular, plus or minus a few degrees, and are located in the same vertical plane.

Preferably, the rotary electrical actuator is a direct-current electric motor.

Advantageously, the rotary electrical actuator is arranged above or below the key. The arrangement of the actuator and mechanical linking means is disposed so as to exert traction on the key of the instrument, so as to form resistance to depression when the user presses on the key and to return the key to its original position when the user does not press the key.

Advantageously, the mechanical linking means are located above or below the key. Preferably, the mechanical linking means comprise a key termination of the mechanical linking means that is attached to an upper or lower face of the key.

Upper face is understood to mean a face oriented upward when the electronic musical instrument is arranged horizontally, and/or a face oriented toward the outside of the instrument. Lower face is understood to mean a face oriented downward when the electronic musical instrument is arranged horizontally, and/or a face oriented toward the inside of the instrument.

The mechanical linking means comprise means for connecting with the key. the connecting means are attached to the key and are arranged to connect the key termination of the mechanical linking means to the key.

The mechanical linking means comprise at least one connecting part corresponding to the key termination. Preferably, the connecting part is placed as far as possible from the pivot axis of the key. This distance makes it possible to exert a greater resistance torque on the key and/or to choose an actuator in a range of devices with lower nominal current, or lower power, decreasing the price and/or inertia of the motor, and/or the price of its electrical control.

For example, the ratio between the lever arm distance separating the pivot axis from the key point where the key termination of the mechanical linking means is attached to the key, on the one hand, and the lever arm distance separating the rotation axis of the rotary electric actuator from an actuator point, where the actuator termination of the mechanical linking means is attached to the actuator shaft, on the other hand, is at least 10, preferably at least 20, advantageously at least 30, advantageously at least 40, advantageously at least 50.

According to one alternative embodiment, the rotary electric actuator is located below the key, for example, above the key return, the key return being attached to or arranged on the underside of the key, for example, in a flat piano.

Preferably, the key termination of the mechanical linking means is attached to an upper face of a key return of the key. The mechanical linking means comprise a connecting part arranged on an upper face of the key return.

Advantageously, the rotary electrical actuator has a diameter or width less than the average width of a key. Preferably, the rotary electric actuator has a diameter or width less than twice the average width of a key.

It may also have a longitudinally elongated shape, accordingly increasing the length of the electrical conductors and therefore the torque available for a given current in the actuator.

According to one embodiment, the mechanical linking means comprise assembly means comprising a winding piece arranged to fit onto the shaft of the rotary electric actuator, and a stirrup-shaped clamping piece having two branches arranged to at least partially surround the winding part.

Preferably, the at least one flexible element is flexible in a single direction. For example, the at least one element flexible in a single direction comprises one or more ribbons or one or more cables.

Firstly, the slight flexing of the flexible element in a single direction serves to ensure at least in part the kinematic compatibility between the rotational movement of the key and the translational movement imposed by the traction of the actuator. The flexibility of the element allows it to wind around the actuator axis. In the case where the mechanical linking means comprise two flexible elements in a single direction, in particular, two ribbons, the kinematic compatibility between the rotational movement of the key and the actuator is carried out by one ribbon, called a key ribbon, and the winding around the actuator axis is made by a ribbon, called an actuator ribbon, which is distinct from the key ribbon, the two ribbons being connected to one another.

Secondly, reduced flexibility (not infinite, as is particularly the case for a wire) serves to prevent the actuator from continuing to rotate when the key is blocked or slowed down in its movement, for example, by the lower stop. Bounces are limited in number and duration by the very particular shape of the longitudinal compressibility of a flexible element in one direction: zero at the buckling limit, then finite beyond the buckling limit.

Preferably, the mechanical linking means comprise at least one ribbon, or at least one cable, that flexes under pressure and stiffens under traction, having a distal termination connected to a hub of the rotary electrical actuator and a proximal termination connected to the key, the ribbon being arranged to work in tension to both:
(i) convert the resistant mechanical torque into resistive force applied at a point of the key being depressed, and
(ii) return the key to its angular rest position.

The at least one ribbon makes it possible to carry out the tension necessary to act on the key while allowing a slight flexing that is used to ensure the compatibility between the rotational movement of the key and the translational movement of the ribbon when it is pulled by the actuator. In addition, the finite flexibility of the ribbon that is used prevents or dispels the bounce vibrations when the key arrives at the end of its stroke.

Preferably, the at least one element that flexes under pressure and stiffens under traction comprises a cable that flexes under pressure and stiffens under traction or a ribbon that flexes under pressure and stiffens under traction.

According to one embodiment, the mechanical linking means comprise at least two ribbons that flex under pressure and stiffen under traction.

According to another embodiment, the mechanical connection means comprise at least two cables that flex under pressure and stiffen under traction.

According to yet another embodiment, the mechanical linking means comprise at least one ribbon that flexes under pressure and stiffens under traction and at least one cable that flexes under pressure and stiffens under traction.

According to yet another embodiment, the mechanical linking means comprise at least three ribbons that flex under pressure and stiffen under traction.

According to one embodiment, the mechanical linking means comprise a single ribbon, the ribbon having an actuator termination arranged to be connected to the actuator shaft and a key termination, opposite the actuator termination, arranged to be connected to a key.

According to one embodiment, the connecting means form a pivot link between the key and the key termination.

For example, the key termination of the mechanical linking means has a cylindrical opening and the connecting means comprise a pivot shaft so that the cylindrical opening can be engaged on and pivot around the pivot shaft. Preferably, the connecting means comprise a removable pivot shaft, also referred to as a connecting shaft, and a body having a bore arranged to receive the removable pivot shaft, the body being arranged to be attached to a key and comprising a slot along a plane transverse to the axis of the bore so as to align the cylindrical opening of the key termination of the mechanical linking means to the bore and to insert the removable shaft into the bore and the opening.

According to one alternative embodiment, the bore has, according to its cross-section, the shape of an oblong hole so that the connecting shaft can translate laterally. Preferably, the longest length of the oblong hole is at least 20% greater than the width (or smallest length) of the oblong hole.

According to another embodiment, the mechanical linking means comprise at least two elements that flex under pressure and stiffen under traction comprising at least two ribbons that flex under pressure and stiffen under traction, and a junction piece arranged between the two ribbons, the junction piece having two ribbon-receiving planes opposite and perpendicular to each other to receive the terminations of the two ribbons.

For example, the mechanical linking means comprise two ribbons, an actuator ribbon arranged to be connected to the actuator shaft and a key ribbon arranged to be connected to the key, and a junction piece arranged between the two ribbons and provided to receive the terminations of the ribbons arranged orthogonally.

According to a particular embodiment, the mechanical linking means comprise three flexible elements, two flexible actuator elements arranged to be connected to the actuator shaft, and a flexible key element arranged to be connected to the key, and a junction piece arranged between the key element and the two flexible actuator elements, the junction piece being arranged to receive the terminations of the three ribbons. Preferably, the two flexible actuator elements are connected to the circumference of the actuator shaft at two diametrically opposite points.

Preferably, the junction piece has two opposite and perpendicular ribbon-receiving planes to receive the two ribbons.

According to one embodiment, the junction piece has two slits opposite and perpendicular to each other to receive the two ribbons, so as to be arranged between the two ribbons. Each slot has a thickness greater than or equal to the thickness of one ribbon.

According to another embodiment, the junction piece comprises two junction pieces arranged perpendicularly to each other, each junction piece having a receiving face for attaching a ribbon. For example, the junction piece comprises two plates extending in the same vertical direction. The plates are arranged perpendicularly to each other, each plate being pierced to receive a means for fastening a ribbon.

Advantageously, ribbons will therefore be used, the central thickness of which is increased relative to the thickness near the junction pieces, or short ribbons, in order to increase both the buckling limit and reduce the compressibility beyond the buckling limit. Preferably, the central thickness is increased relative to the thickness of the portion of the ribbon that is not wound on the actuator shaft.

According to alternative embodiments, which can be combined with one or more ribbons or a cable, the mechanical linking means comprise a return component.

Preferably, the mechanical linking means comprise at least two flexible elements, a flexible actuator element arranged to be connected to the actuator shaft and a flexible key element arranged to be connected to the key, and a return part having a pivot axis, the return part being arranged between two flexible elements, the return part being arranged to produce a non-rectilinear trajectory of the mechanical linking means.

According to a particular embodiment, the mechanical linking means comprise three ribbons, an actuator ribbon arranged to be connected to the actuator shaft, a first key ribbon, a junction piece arranged between the actuator ribbon and the first key ribbon, a second key ribbon arranged to be connected to the key, and a return component arranged between the first key ribbon and the second key ribbon and provided to receive the terminations of the ribbons extending orthogonally.

For example, the return part is an “L”-shaped levered actuation part or a pulley.

According to a first alternative embodiment, the return part is a fixed or rotating pulley, such that a ribbon or a cable is in contact with the pulley. In operation according to a particular arrangement of the pulley, the pulley performs a quarter-turn, or the ribbon or the cable travels a quarter of the circumference of the fixed pulley. Preferably, the mechanical linking means further comprise a counter-pulley or axis guide parallel to the axis of the pulley. The counter-pulley or the guide is arranged near the pulley so that the ribbon or the cable is in contact simultaneously with the pulley on the one hand, and the counter-pulley or the guide on the other hand.

According to a second alternative embodiment, the mechanical linking means comprise a levered actuation part. For example, the levered actuation part has the shape of an “L” or a bracket. The levered actuation part comprises a rotation axis at the intersection point of the two arms of the “L” or of the two arms of the bracket. According to one embodiment, the “L” actuation part is arranged under the key and is connected close to the key return.

Optionally, the levered actuation part may form a junction piece. One or both ends of the part may comprise a slot as defined above for the junction piece.

In a non-exhaustive manner, the various embodiments comprising a combination of features proposed above are shown:
the rotary electric actuator has a rotation axis parallel to the axis of the key, the mechanical linking means comprising a cable or a ribbon connecting the actuator to the key;
the rotary electric actuator has a rotation axis parallel to the axis of the key, the mechanical linking means comprising a cable or a ribbon connecting the actuator to the key, and a return part between the actuator and the key in order to modify the trajectory of the cable or of the ribbon, the return part having a pivot axis parallel to the axis of the key;
the rotary electric actuator has a rotation axis parallel to the axis of the key, the mechanical linking means comprising two flexible elements, which can be two cables or two ribbons or a cable and a ribbon, connecting the actuator to the key, and a return part having a pivot axis parallel to the axis of the key, the two flexible elements being separated by the return part;
the rotary electric actuator has a rotation axis parallel to the longitudinal direction of the key, the mechanical linking means comprising a cable connecting the actuator to the key;
the rotary electric actuator has a rotation axis parallel to the longitudinal direction of the key, the mechanical linking means comprising a ribbon connecting the actuator to the key, and connecting means comprising a bore with an oblong hole-shaped section so as to achieve an operating clearance in a direction parallel to the longitudinal direction of the key;
the rotary electrical actuator has a rotation axis parallel to the longitudinal direction of the key, the mechanical linking means comprising two ribbons connecting the actuator to the key, and a junction piece being arranged between the two ribbons;
the rotary electric actuator has a rotation axis perpendicular to the longitudinal direction of the key and to the rotation axis of the key, the mechanical linking means comprising two flexible elements, the two flexible elements being able to be one or two cables or two ribbons or a ribbon and a cable, connecting the actuator to the key, and a return part having a pivot axis parallel to the axis of the key, the two flexible elements being separated by the return part, the return part also being able to be a junction piece in the presence of one or two ribbons;
the rotary electric actuator has a rotation axis perpendicular to the longitudinal direction of the key and to the rotation axis of the key, the mechanical linking means comprising two flexible elements, the two flexible elements being able to be two ribbons or a ribbon and a cable, connecting the actuator to the key, and an “L”-shaped leveed actuation part having a pivot axis parallel to the axis of the key, the two flexible elements being separated by the levered actuation part, the levered actuation part comprising, at the end intended to connect the actuator ribbon, a bore with an oblong hole-shaped section so as to achieve an operating clearance in a direction parallel to the longitudinal direction of the key;
the rotary electric actuator has a rotation axis perpendicular to the longitudinal direction of the key and to the rotation axis of the key, the mechanical linking means comprising two ribbons connecting the actuator to the key, a junction piece being arranged between the two ribbons, and a return part, in particular, a pulley, in addition to the junction piece, having a pivot axis parallel to the axis of the key, the return part being arranged so as to be in contact with the key ribbon in order to modify its trajectory;
the rotary electric actuator has a rotation axis perpendicular to the longitudinal direction of the key and to the rotation axis of the key, the mechanical linking means comprising three ribbons, or two ribbons and a cable, connecting the actuator to the key, a junction piece being arranged between the two first ribbons, and a return part, in particular, a levered actuation part, in addition to the junction piece, having a pivot axis parallel to the axis of the key, the levered actuation part being arranged between the second ribbon and the third ribbon or cable.

According to another particular embodiment, the mechanical linking means comprise at least two ribbons, an actuator ribbon arranged to be connected to the actuator shaft and a key ribbon arranged to be connected to the key, a junction piece arranged between the two ribbons, and provided to receive the terminations of the ribbons arranged orthogonally relative to one another, and a pulley on which the key ribbon cooperates.

According to other alternative embodiments, the rotary electrical actuator has a rotation axis perpendicular to the longitudinal direction of the key and to the rotation axis of the key, and offset relative to a plane passing through the thickness of the key. In these cases, the return parts have a pivot axis parallel to the longitudinal direction of the key. In this configuration, the various embodiments comprising a combination of features proposed above are shown:
the mechanical linking means comprising two flexible elements, the two flexible elements being able to be two cables or two ribbons or a ribbon and a cable, connecting the actuator to the key, and a return part separating the two flexible elements, the return part being able to be a pulley or “L”-shaped levered actuation part, in the case of an actuator ribbon and an “L”-shaped levered actuation part, the latter being able to comprise at the end intended to connect the actuator ribbon, a bore with an oblong hole-shaped section so as to achieve an operating clearance in a direction parallel to the pivot axis of the key, and/or in the case of a key ribbon, the mechanical linking means comprising linking means comprising a hole with an oblong hole-shaped section so as to achieve an operating clearance in a direction parallel to the longitudinal direction of the key;
the mechanical linking means comprising two ribbons connecting the actuator to the key, a junction piece separating the ribbons and a pulley having a pivot axis parallel to the longitudinal direction of the key and being arranged so as to be in contact with the key ribbon in order to modify its trajectory;
the mechanical linking means comprising three flexible elements, which may be three ribbons or two ribbons and one cable, connecting the actuator to the key, a junction piece separating the first and second ribbons and/or a junction piece separating the second and third ribbons, a pulley having a pivot axis parallel to the longitudinal direction of the key and being arranged so as to be in contact with a ribbon in order to modify its trajectory, and an “L”-shaped levered actuation part separating two flexible elements, the mechanical linking means comprising connecting means comprising a bore with an oblong hole-shaped section so as to achieve an operating clearance in a direction parallel to the longitudinal direction of the key;
the mechanical linking means comprising four ribbons connecting the actuator to the key, a junction piece separating the first and second ribbons and/or a junction piece separating the third and fourth ribbons, and an “L”-shaped levered actuation part separating the second and third ribbons.

According to one embodiment, the mechanical linking means comprise at least two ribbons, an actuator ribbon arranged to be connected to the actuator shaft and at least one key ribbon arranged to be connected to the key, and a levered actuation part arranged between the two ribbons and provided to receive the terminations of the ribbons arranged orthogonally.

For example, each ribbon has the following dimensions:
actuator ribbon:
   length comprised between 25 and 50 millimeters, preferably between 15 and 40 millimeters, preferably greater than 15 millimeters,
   width comprised between 5 and 10 millimeters, and
   thickness of 0.05 millimeters,
key ribbon:
   length comprised between 15 and 30 millimeters, preferably between 5 and 30 millimeters, preferably greater than 5 millimeters, preferably greater than 10 millimeters,
   width comprised between 5 and 10 millimeters, and
   thickness of 0.05 millimeters.

Preferably, the mechanical linking means are metal linking means. The actuator and key ribbons may be metal actuator and key ribbons.

The material of the ribbons comprises or consists of metal (steel, preferably stainless steel, or aluminum), or a fiber or composite polymer material, and/or synthetic fiber textile, for example, KEVLAR®.

The ribbons make it possible to carry out the tension necessary to act on the key while allowing a slight flexing to ensure the compatibility between the rotation of the key and the translational movement of the key tape when it is pulled by the actuator. A second function, provided by the limited flexibility of the ribbons, consists, when the key is slowed down, of limiting the stroke of the actuator driven by its own inertia. They make it possible to prevent or dispel bounce vibrations. Furthermore, the flexible ribbon link does not have the disadvantage of backlash and has the advantage of a stable equilibrium configuration during the release of the tensile force.

According to another embodiment, the haptic device comprises an actuator stop arranged at the periphery of the rotation shaft of the actuator or around the rotation shaft, so as to control the angular travel of the rotation shaft of the actuator, in particular, if the connecting means implement cables. For example, the stop may be arranged on the rotation shaft of the actuator or near the shaft, for example, tangentially arranged. According to one embodiment, the stop is cylinder-shaped. The actuator stop is placed in the immediate vicinity of the connecting means or of the actuator. Preferably, the actuator stop is reached at the moment when the key reaches the stop position.

The presence of the at least one element that flexes under pressure and stiffens under traction and/or the presence of the actuator stop constitute mechanical means for controlling the displacement of the mechanical linking means. The control means make it possible to control the angular travel of the rotation shaft of the actuator as a function of the angular travel of the key. They also make it possible to avoid undesired movements of the linking means, or excessive movements.

Advantageously, the mechanical means for controlling the displacement of the mechanical linking means are mechanical in nature and are located in the immediate vicinity of the linking means and the actuator, the means having the function of retaining the linking means and the actuator with the geometric configuration they have in absolute terms and with respect to the key at the moment when the tension ceases.

Preferably, the mechanical means for controlling the movement of the mechanical linking means are the at least one flexible element. The use of ribbons largely makes it possible to ensure this geometric restoration function by virtue of its stable, natural equilibrium configuration.

A wire connection, in particular, not having a natural configuration of stable equilibrium, has the disadvantages of being difficult to attach and complicated at limiting of the stroke of the motor, which must be ensured by other means: actuator stop or electrical position control means.

In a complementary manner, the actuator can be controlled according to a four- quadrant operation, to participate in the control of the mechanical linking means and prevent the motor from rotating under its own momentum.

Preferably, the haptic device further comprises means for holding the key in the high position. Holding it in the high position is understood to mean holding it in the original position. The high position holding means also allow the key to be returned to the original position when the user is not pressing the key. In particular, the high position holding means can be independent of the rotary electric actuator. For example, the high position holding means may comprise at least one spring, at least two permanent magnets, or a holding actuator through which a current continuously passes when the key, thus equipped, is not in use.

According to another embodiment, the computing means can control the rotary electrical actuators to perform the high position holding function via the mechanical linking means. Preferably, the computing means comprise four-quadrant control means for actuating the electrical actuator.

The detection means are arranged and configured to detect or measure the position and/or the acceleration of the associated key or the effort applied by the user to the associated key. They make it possible to inform the calculation algorithm implemented by the computing means.

Preferably, the key detection means comprise sensors for the kinematics of the key. The sensors are, for example, of the position sensor, motion sensor, acceleration sensor, angular speed sensor.

The key detection means comprise force sensors, for example, of the strain gauge type.

According to one embodiment, the key detection means comprise two sensors.

According to a variant embodiment, the detection means are placed under the key, preferably on the lower face of the key.

According to another embodiment, the detection means comprise a means for measuring the current of the actuator.

The computing means preferably comprise an integrated microprocessor on an autonomous board, a control interface and software comprising a mathematical model of the dynamics of the mechanism of the real instrument that it is sought to reproduce.

Preferably, the computing means comprise an actuator module integrating a mechanical model for controlling at least one key of at least one acoustic musical instrument. The module integrates the mathematical model of the dynamics of the mechanism of the real instrument that it is sought to reproduce. The module also integrates the mathematical model of the dynamics of the mechanism of the digital keyboard used to reproduce the real instrument, in the absence of electrical control. Preferably, the computing means comprise an actuator module integrating a mechanical model for controlling at least one key of the keyboard described herein, when the associated actuator is not receiving any electric current. The module integrates the mathematical model of the dynamics of the mechanism of the keyboard used to reproduce the real instrument, made passive by the absence of electrical control. The module also incorporates a mathematical model of the dynamics of the key, linking means and actuator, in the absence of electrical control.

Regarding the mathematical model of the dynamics of the mechanism of the real instrument that it is sought to reproduce, reference may be made, for example, to the paper “Non-smooth model of the grand piano action” by Anders Thorin (https://pastel.archives-ouvertes.fr/pastel-00939493).

According to a second aspect, the present disclosure proposes a haptic-feedback electronic musical instrument keyboard comprising at least one key and at least one haptic device, each key being associated with a device according to one or more of the features of the first aspect.

According to a third aspect, the present disclosure proposes an electronic musical instrument, for example, an electronic piano, comprising at least one haptic device according to one or more of the features of the first aspect or comprising a keyboard according to the second aspect.

Preferably, the electronic musical instrument comprises several haptic devices. The haptic devices are arranged next to one another. According to one embodiment, the haptic devices are arranged so that the rotary electrical actuators are arranged parallel to one another.

According to a fourth aspect, the present disclosure proposes a method for controlling an electronic musical instrument comprising at least one haptic device according to one or more of the features of the first aspect.

The method aims to control, as a function of a given movement of a user on a key and measured by the pressure detection means, the at least one rotary electrical actuator associated with the key so as to exert a predetermined retaining force against the load force of the user. This retention force substantially corresponds to a force that would opposite the key of a similar traditional or acoustic instrument to obtain the same movement, and thus to emulate the dynamics of traditional instrument mechanisms.

The control method comprises at least the following steps:
a step of detecting the user pressing the key, by the detection means, and
a step of real-time control of the actuator to exert a tensile force on the key so as to resist the pressing force, or to exert a tensile force so as to return the key into its original position.

The detection means periodically measure the position and/or the acceleration of the key and then transmit this information to the computing means. The computing means compute the forces generated in a real instrument mechanism from a mathematical model of the dynamics of the mechanism.

The computing means must have a sufficient computing capacity to simulate the model of the key in real time. The cycle time (Measurement/Computing/Actuation) is constrained and defined by the movement of the piano key. The sampling frequency is, for example, 2 kHz. At lower values, the simulation of the traditional piano key has instabilities. The computing means are, for example, a computer.

Preferably, in order to transmit the information between the various components, the computing means further comprise:
power electronics,
signal electronics,
computing boards based on a real-time simulation model,
a MIDI (Musical Instrument Digital Interface) hub, and
a router.

The function of the computing means is to process the measured signals, computer the dynamics of the traditional keyboard and of the digital key (simulation) in real time, and to develop the command to be applied to the actuator.

The computing means compute the current or the voltage to be applied to the actuator, based on a dynamic model of the musical instrument to be simulated and real-time measurements from the detection means.

The control method according to the present disclosure thus makes it possible to emulate or simulate dynamics of mechanisms that are:
tunable and changeable at low expense,
different, on the same keyboard but referring to different instruments, for example, harpsichord, fortepiano, clavichord or organ;
non-existent in acoustic instruments but could be desired, for example, regarding modern light-touch pianos, which would allow, for example, for better control by very young piano learners;
non-existent due to physical problems, such as keys without dry friction, the escapement point of the hammer extremely close to the point of impact on the wire, and that are desirable for different reasons, for example, greater ease of control when playing at “piano” marking, greater possible repetition rate, but whose possible adoption may pose a few ecological problems.

The computing boards perform in real time the calculations to emulate the dynamics of the keys of a traditional keyboard, via the processing of the signals from the sensors, and the measurement of the power electronics circuits associated with the actuators and optionally via the application of control algorithms for the force signal, aiming to correct certain imperfections of the system, for example, delays.

According to a preferred configuration wherein an actuator is associated with a single key, the control method provides for a closed-loop control of the at least one rotary electrical actuator so that the at least one actuator exerts a variable force over time, according to the command given by the computer in real time and relayed by power electronics.

Each computing board provides the MIDI codes corresponding to the notes played on the keys that it controls, using an electronic circuit. The codes are transformed into signals in accordance with the MIDI standard. The signals of the various computing boards are transmitted to a MIDI (internal or external) hub, which sends the MIDI codes necessary for sound synthesis to the computer (as for autonomous prototypes) or to the digital piano. For autonomous prototypes, the computer performs sound synthesis by means of sound synthesis software, for example, the software PIANOTEQ®.

### BRIEF DESCRIPTION OF THE DRAWINGS

Other features and advantages of the present disclosure will emerge from the following detailed description of example embodiments of the present disclosure with reference to the appended figures, and wherein:

FIG. 1 is a schematic profile view of a haptic control device according to a first embodiment associated with a key of an electronic upright piano, the device comprising an electric motor and mechanical linking means of the metal ribbon type between the motor and an upper face of the key, the rotation axis of the motor being parallel to the longitudinal direction of the key;

FIG. 2A is a schematic profile view according to FIG. 1 showing in an exaggerated manner the movement of the key and the mechanical linking means, FIG. 2A illustrating the original position;

FIG. 2B is a schematic profile view according to FIG. 1 showing in an exaggerated manner the movement of the key and the mechanical linking means, FIG. 2A illustrating a stop position when a user presses the key;

FIG. 3A is a perspective view of three haptic control devices according to the first embodiment, each device comprising mechanical linking means according to one embodiment;

FIG. 3B is a detailed view of FIG. 3A in the zone having the rotation shafts of the actuators, each device comprising an actuator stop arranged near the respective rotation shaft;

FIG. 4A is a schematic profile view of a haptic control device according to a second embodiment, wherein the motor is located below the lower face of the key and the mechanical linking means are located above the upper face of the key return of a flat piano, the rotation axis of the actuator being parallel to the longitudinal direction of the key;

FIG. 4B is a cross-sectional view of an example embodiment of a haptic device according to FIG. 4A;

FIG. 4C is a perspective view of an example embodiment of a haptic device that is a variant of the embodiment shown in FIG. 4A;

FIG. 4D is a top perspective view of the system of the preceding figure;

FIG. 5A is a schematic perspective view of a haptic control device according to a third embodiment, wherein the motor and the mechanical linking means are located above the upper face of a key, the rotation axis of the actuator being perpendicular to the longitudinal direction and the pivot axis of the key, the mechanical linking means further comprising a pulley cooperating with the key ribbon;

FIG. 5B is a view in accordance with FIG. 5A, and further comprising a counter-pulley whose peripheral surface is in contact with the key ribbon, the counter-pulley being arranged substantially tangentially to the pulley;

FIG. 5C is a schematic perspective view of a haptic control device according to a fourth embodiment, wherein the motor and the mechanical linking means are located above the upper face of a key, the rotation axis of the actuator being perpendicular to the longitudinal direction and the pivot axis of the key, the mechanical linking means further comprising a rotating bracket and an additional ribbon located between the actuator ribbon and the bracket;

FIG. 6A is a schematic profile view of a haptic control device according to a fifth embodiment, wherein the motor is located below the lower face of the key and the mechanical linking means are connected to the upper face of the key return of a flat piano, the rotation axis of the actuator being perpendicular to the longitudinal direction and to the pivot axis of the key, the mechanical linking means further comprising a pulley, the key ribbon guide being able to be placed in the immediate vicinity of the pulley is not shown;

FIG. 6B is a schematic profile view of a haptic control device according to a sixth embodiment, wherein the motor is located below the lower face of the key and the mechanical linking means are connected to the upper face of the key return of a flat piano, the rotation axis of the actuator being perpendicular to the longitudinal direction and to the pivot axis of the key, the mechanical linking means further comprising a rotation bracket and an additional ribbon located between the bracket and the actuator ribbon, the latter being guided by a series of double guides with vertical axes;

FIG. 6C is a cross-sectional view of an example embodiment of a haptic device according to FIG. 6B, further comprising actuator ribbon guides;

FIG. 6D is a partial perspective view of a haptic control device according to a variant embodiment comprising an actuator stop arranged near the actuator rotation shaft, FIG. 6D showing the state wherein the assembly means of the actuator ribbon are in contact with the stop;

FIG. 6E is a profile view of an example embodiment of a haptic device that is a variant of the embodiments shown in FIGS. 6A-6C, comprising a winch wheel;

FIG. 7 is a perspective view of assembly means according to one embodiment;

FIG. 8A is a perspective view of an example embodiment of the junction piece between two ribbons;

FIG. 8B is a perspective view of another example embodiment of the junction piece between two ribbons;

FIG. 9A is a perspective view of an example embodiment of a connecting piece;

FIG. 9B is a perspective view of another example embodiment of a connecting piece;

FIG. 10 shows an electrical diagram of a haptic control device;

FIG. 11 shows a diagram for computing the retention forces as a function of the dynamics of traditional or acoustic instruments;

FIG. 12 is a schematic perspective view of a haptic control device according to a seventh embodiment associated with a key of an electronic upright piano, the device comprising an electric motor and mechanical linking means comprising a single metal ribbon between the motor and an upper face of the key, the rotation axis of the motor being parallel to the pivot axis of the key;

FIG. 13 is a schematic perspective view of four haptic control devices, two haptic control devices being in accordance with the preceding embodiment and two haptic control devices according to an eighth embodiment, wherein each device comprises a motor located below the lower face of the associated key and mechanical linking means linking a key return of the associated key, the mechanical linking means comprising a single metal ribbon between the motor and a face of the key return of the key, the rotation axis of the motor being parallel to the pivot axis of the key, one of the two devices further comprising a return pulley;

FIG. 14 is a schematic perspective view of a haptic control device according to a ninth embodiment associated with a key of an electronic upright piano, the device comprising an electric motor and mechanical linking means comprising a single metal ribbon between the motor and an upper face of the key, the rotation axis of the motor being parallel to the longitudinal direction of the key, the mechanical linking means comprising connecting means arranged to achieve an operating clearance in the longitudinal direction;

FIG. 15 is a perspective view of the connecting means according to FIG. 14 having a bore along an axis perpendicular to the longitudinal direction of the key;

FIG. 16 is a perspective view of three haptic control devices according to a tenth embodiment, each device comprising mechanical linking means according to a particular embodiment comprising two flexible actuator elements per device;

FIG. 17 is a perspective view of a haptic control device according to an eleventh embodiment, which is a variant of the preceding embodiment.

For greater clarity, identical or similar elements of the various embodiments are denoted by identical reference signs in all of the figures.

### DETAILED DESCRIPTION

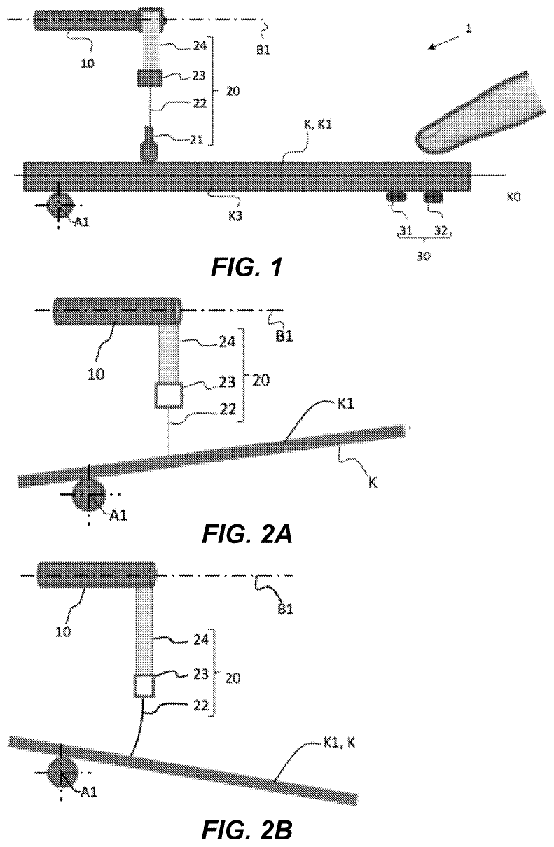

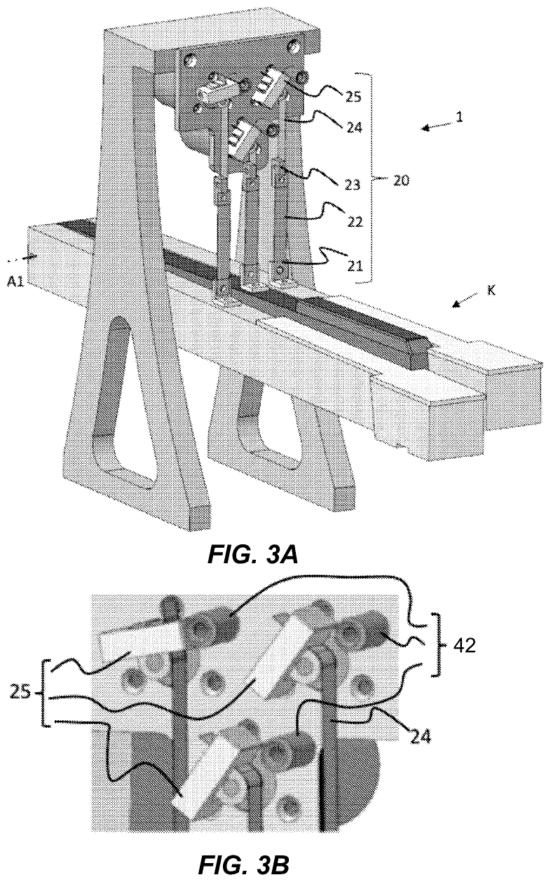

FIGS. 1, 2A, and 2B show a first embodiment of a haptic control device 1 of an electronic musical instrument. The instrument, for example, a piano as shown in FIGS. 3A and 16, is a musical instrument composed of a keyboard comprising several keys, a single key of which is shown in FIGS. 1, 2A, and 2B.

The haptic device and the key K are seen in profile view, the key being represented by a horizontal rectangle. The key K shows a piano key. It is pivotably mounted about the pivot axis A1 relative to a frame, for example, the frame of a keyboard, see FIGS. 3A and 16. The pivot axis A1 is represented by two dashed lines perpendicular to each other representing a target, on a disc representing a rotation shaft. The pivot axis A1 is shown under the key K near a first end, called the proximal end, of the key, on the left in FIGS. 1, 2A, and 2B. Near a second end, called the distal end, opposite the first end, and above the upper face K1 of the key, a finger of a user of the musical instrument is shown, only visible in FIG. 1.

Under the key, near the distal end, the haptic device comprises means 30 for detecting and/or measuring the pressing and movement of the key by the user. With reference to FIG. 1, the detection and/or measurement means comprise two motion sensors 31, 32, for example, accelerometers. They are arranged to measure the movements of the key and to transmit this information to the computing means, also called servo and control means, of the haptic device, not shown.

The haptic control device 1 comprises a rotary electric actuator 10. Preferably, the actuator is a direct-current electric motor whose drive shaft extends along the axis B1. The motor is arranged relative to the key K so that the rotation axis B1 is parallel to the longitudinal direction K0 of the key K, in particular, in the original position, and that the direction K0 and the axis B1 are aligned vertically. In this embodiment, the rotation axis B1 is substantially horizontal.

With reference to FIGS. 1, 2, 3A, and 16, the haptic control device further comprises mechanical linking means 20 connecting the shaft of the motor 10 to the upper face K1 of the key. The mechanical linking means 20 comprise a plurality of elements or parts connected one after another: assembly means 25 (not visible in FIGS. 1 and 2), an actuator ribbon 24 (two actuator ribbons 24a, 24b in FIG. 16), a junction piece 23, a key ribbon 22 and connecting means 21.

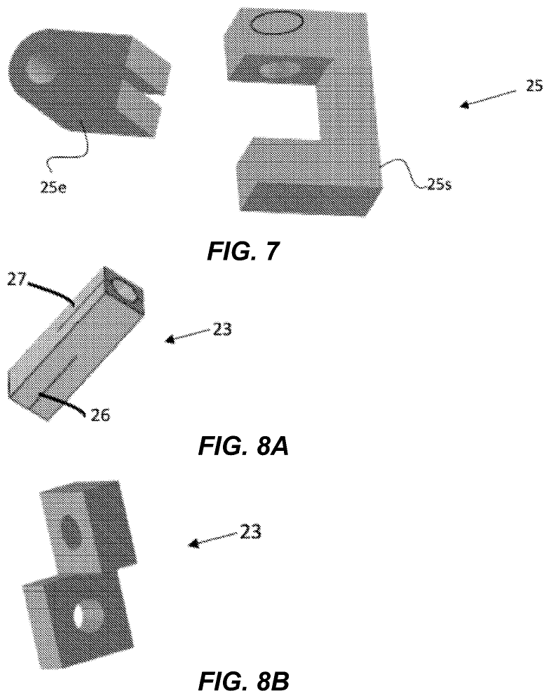

The assembly means make it possible to connect the actuator ribbon to the rotation shaft of the electric motor, see FIGS. 3A and 3B. For example, with reference to FIG. 7, the assembly means 25 comprise a winding part 25e and a clamping piece 25s, or stirrup having two branches. The winding part has a bore arranged to be fitted onto the rotation shaft of the electric motor, see FIGS. 3A and 3B. It further has a rectangular portion extending radially relative to the bore, in which portion a slot is produced in order to allow the fitting. The clamping piece 25s is U-shaped in order to overlap the rectangular portion of the winding part 25e. The clamping piece comprises, in one of its branches, an internal thread arranged to be perpendicular to the rectangular portion of the winding piece. When the actuator ribbon is attached, it is pressed between an interior face of the clamping piece and a first exterior face of the rectangular portion, see FIGS. 3A and 3B. The face opposite the first face receives the end of a screw that is mounted in the internal thread of the clamping piece. The screwing action makes it possible both to close the slot of the rectangular portion of the winding piece in order to tighten the latter onto the drive shaft and press until the termination of the actuator ribbon is clamped.

The actuator ribbon 24 is located between the assembly means 25 and the junction piece 23. The actuator ribbon extends vertically and tangentially to the rotation shaft of the motor.

The key ribbon 22 is located between the junction piece 23 and the connecting means 21. The key ribbon extends vertically and along a plane parallel to the plane transverse to the key, in particular, in the original position.

According to another embodiment and with reference to FIG. 16, which will be described by its differences relative to FIG. 3A, the mechanical linking means 20 comprise a pair of actuator ribbons 24a and 24b. Each ribbon 24a, 24b connects the actuator 10 to the junction piece. The two ribbons are attached, via sleeve-shaped assembly means 25, to the circumference of the shaft of the actuator 10. The actuator terminations of the ribbons 24a, 24b are arranged diametrically opposite. The actuator ribbon 24a is connected directly between the junction piece and the actuator. The actuator ribbon 24b is connected between the junction piece and the actuator by means of a wheel 11. The wheel 11 is positioned raised relative to the actuator so that the ribbon 24b winds around the wheel 11 before being attached at a point of the circumference of the actuator that is substantially diametrically opposite the point of attachment of the actuator termination of the ribbon 24a. This arrangement makes it possible, during the actuation of the actuator, to exert a double traction in the opposite direction around the actuator shaft. The ribbons of actuators 24a and 24b are arranged substantially symmetrically relative to a plane parallel both to the axis of the actuator and the longitudinal direction of the key associated with the device comprising the ribbons.

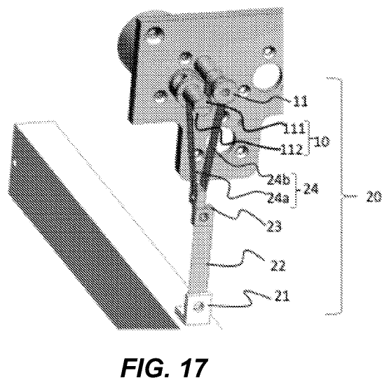

According to an alternative embodiment represented by FIG. 17, the actuator comprises two half-shafts 111, 112 and the mechanical linking means 20 comprise a single actuator ribbon 24 that passes between the two half-shafts of the drive shaft before being connected to the wheel 11. Each half-shaft has along its longitudinal axis a rectangular face, one side of which corresponds to the diameter of a shaft and a curved face corresponding to a circular half-cylinder. The junction of the half-shafts makes it possible to obtain a shaft.

The ribbon (or the cable) passes through the shaft of the actuator (motor) between two half-rods clamped together on the axis of the motor by virtue of the clamping piece comprising two half-cylinders tightened onto each other, for example, by two screws.

The two ends of the ribbon (or cable) meet on the key. In this way, the two ends of the ribbon (or cable) exert the same force on the key (and these forces are cumulative), but also exert opposite-sign forces on the axis of the motor. Consequently, a force is exerted on the key, and a pair of forces that cancel each other out are exerted on the motor.

In order for the force exerted on the key to make it possible to pull straight in the vertical axis without deviating transversely, an intermediate direction-changing member, for example, a pulley or a wheel 11, is used.

Referring to FIG. 8A, the junction piece 23 comprises two mutually opposite and perpendicular slits 26, 27 to receive the terminations of the two ribbons 22, 24. The junction piece performs the function of a ribbon orientation converter. A first end of the junction piece has the slot 26 arranged to receive the termination of the actuator ribbon 24, and a second end, opposite the first end, has the slot 27 arranged to receive the termination of the key ribbon 22.

According to another embodiment of the junction piece shown in FIG. 8B, the junction piece 23 comprises two plates extending in the same vertical direction. The plates are arranged perpendicularly to each other, each plate being pierced to receive a means for fastening a ribbon.

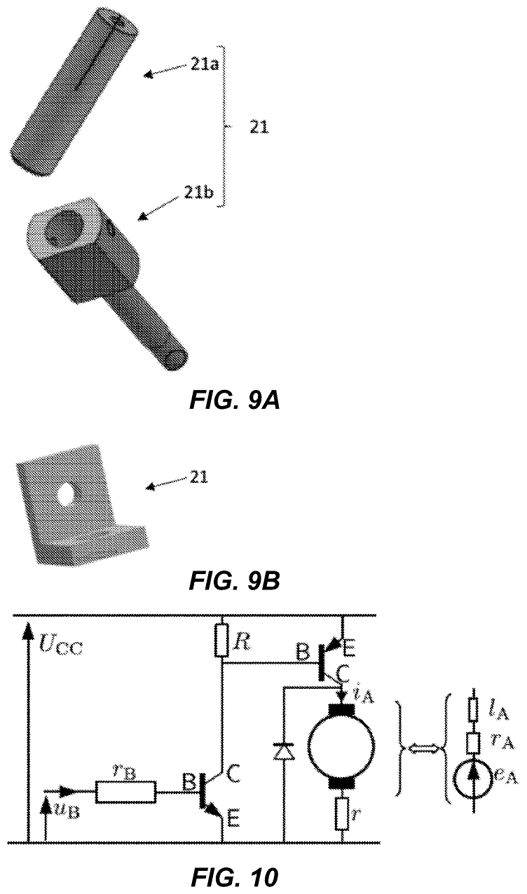

Finally, the connecting means 21 are attached to the upper face K1 (in FIGS. 1, 2A, and 2B) of the key K. With reference to FIG. 9A, the connecting means have the form of two rods: a linking rod 21a and a key rod 21b. The linking rod a comprises at one end, called the slot end, a slot arranged to receive a key ribbon termination. The slot is directed along a plane that is parallel to the transverse plane of the key. The key rod comprises a threaded body arranged to fit into an internal thread made in the key. The key rod comprises a hollow body for receiving an end of the connecting rod, opposite the slot end. The peripheral wall of the hollow body comprises an internal thread extending radially in order to receive a screw making it possible to lock the position of the linking rod in the key rod.

According to another embodiment shown in FIG. 9B, the connecting means 21 comprise two plates arranged perpendicularly to each other and in different directions. A first plate extends horizontally to be attached to the key K and the second plate extends vertically to be connected to the key ribbon. Each plate comprises a bore for the passage of a screw.

Referring to FIG. 1, the connecting means are positioned on the key, at a key point located at a distance equal to 25% of the longitudinal distance of the key from the pivot axis A1. Preferably, the key point is located between the middle of the key and the distal end of the key. Preferably, they are attached as far as possible from the pivot axis A1.

For example, the connecting means are arranged on the key so that the key point is at a distance of at least 50 millimeters, preferably at least 100 millimeters, advantageously at least 150 millimeters from the pivot axis. The assembly means, in particular, the winding piece, are arranged on the axis of the motor so that the actuator point is situated at a distance of 3 millimeters from the axis of the motor. In the case of these latter indications (150 and 3 millimeters), the ratio of reduction of angular displacement between the motor and the key, or torque multiplication ratio, is equal to 50.

Preferably, each slot, or each hole of the linking parts, is associated with a fastening means, for example, a screw. For example, an internal thread extends radially or perpendicularly to the axis of the part in order to receive a screw.

With reference to FIG. 2A, the key K is located in a substantially horizontal or raised position. When pressing on the upper face K1 and near the distal end of the key, the latter is pivoted so that the distal end lowers and the key ribbon 22 tilts and bends due to the pivoting of the key, see FIG. 2B. The actuator ribbon 24 is uncoiled while remaining vertical and being retained by the electric motor 10 that is supplied with current so as to reproduce the dynamics of a keyboard mechanism of an acoustic instrument (or any other dynamics previously determined). Each motor is controlled by current. Upon pressing, the torque of the motor makes it possible to brake the descent of the key (generator operation). Upon release, the same current control makes it possible to raise the key (motor operation). The torque generated by the motor always retains the same sign; only the direction of rotation changes between the pressing and releasing of the key (two-quadrant operation). FIG. 10 shows the diagram of the power electronics of the device. According to another embodiment, the computing means can control the actuator in order to carry out, using the ad hoc modifications of the power electronics diagram, a four-quadrant operation.

Referring to FIGS. 3A and 3B, the arrangement of electric motors is shown in the case of a keyboard comprising a plurality of keys, in particular, black and white keys of a piano. The electric motors are arranged so that the rotation shafts are arranged in two horizontal rows and offset so that the mechanical linking means are aligned.

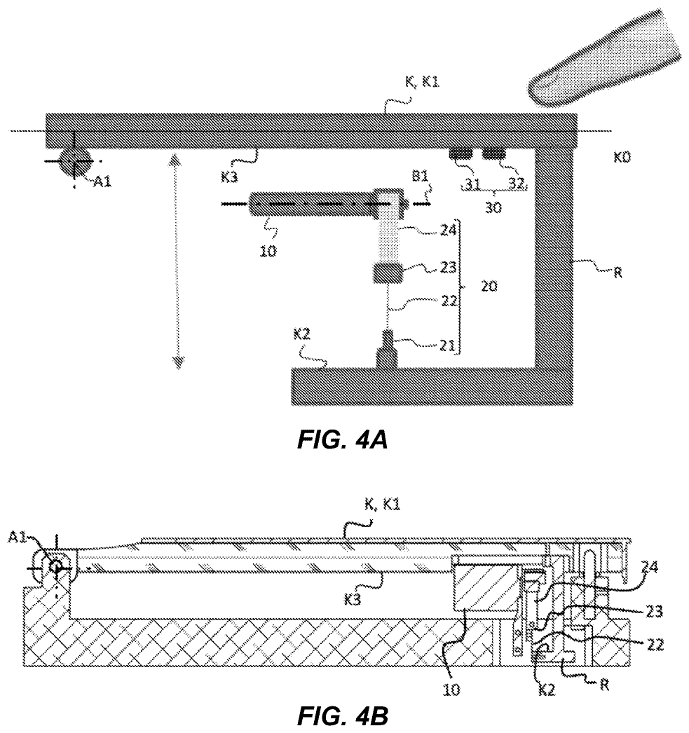

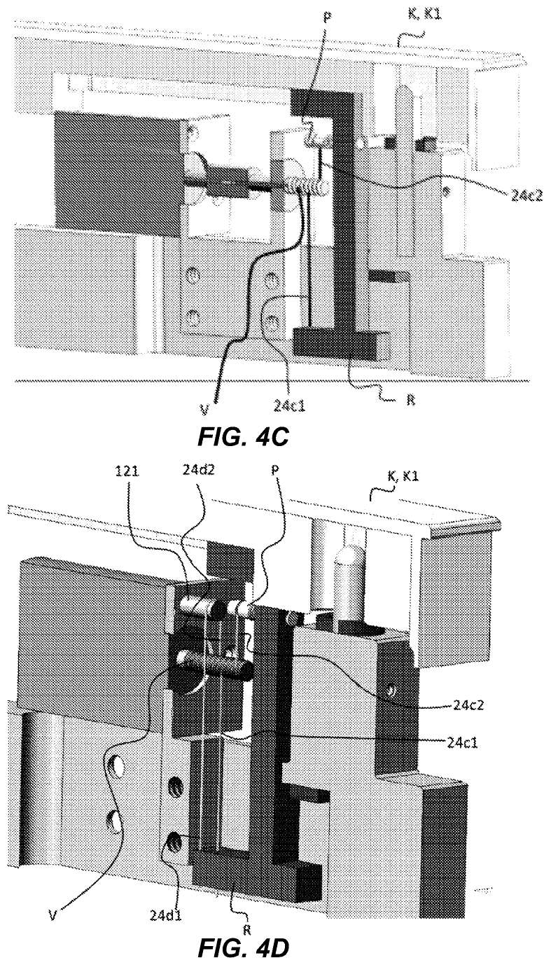

FIGS. 4A and 4B show a second embodiment that will be described by its differences relative to the preceding one.

The key shown corresponds to a key of a flat piano, the key comprising a key return R extending under the key from the distal end so as to form an “L.” In this case, the rotary electric actuator and the mechanical linking means are located above the upper face K2 of the key return. The distance separating the upper face K2 of the key return from the lower face K3 is, for example, equal to 45 millimeters. With reference to FIG. 4A, the connecting means are attached to the upper face K2 of the key return. With reference to FIG. 4B, the termination of the key ribbon is attached to the distal transverse face of the key return R.

According to an alternative embodiment shown in FIG. 4B, the lower face K3 of the key may have a recess, for example, of concave shape, in order to partially receive the actuator. This feature makes it possible to propose an even more compact device.

According to another alternative embodiment shown in FIG. 4C, and that will be described by its differences relative to FIG. 4A, the device comprises a threaded rod arranged at the end of the drive shaft of the actuator. Preferably, the threaded rod is a screw V.

Furthermore, the device comprises an attachment finger P arranged on the key return. The finger is located above the threaded rod, preferably substantially parallel to the drive shaft or the threaded rod. According to the embodiment shown, the attachment finger has a cylindrical shape and is attached to a face perpendicular to the upper face K1.

In addition, the mechanical linking means 20 comprise two cables, a cable 24c1 connecting the distal end of the key return to the threaded rod, and a cable 24c connecting the threaded rod to the attachment finger.

In operation, the key return R and the attachment finger P are integral in translation, for example, vertical according to the embodiment shown, when the key descends or rises. The screw V is integral with the actuator axis and is rotatable along the geometric axis of the drive shaft. The threaded rod, in particular, the screw V, does not translate.

Preferably, the mechanical linking means 20 comprise a single cable 24c having two strands 24c1 and 24c2. In the latter case, the cable 24c is wound in one or more turns around the screw V and is attached to the screw in order to prevent the cable from sliding. For example, the cable 24c is attached to the screw or the threaded rod by gluing. Preferably, the strands or cable portions 24c1 and 24c2 emerge on the same side of the threaded rod or the screw V. The role of the strand of cable 24c2 (the end of which is secured to the key) is to lock the rotation of the actuator by stopping its momentum when the key arrives at the bottom stop. The cable strand 24c2 exerts force only when the key is stopped, serving only to hold the motor. In operation and when pressing the key, the strand of cable 24c2 winds around the screw V and the cable strand 24c1 is uncoiled from the screw V.

According to yet another alternative embodiment represented by FIG. 4D, and that will be described by its differences relative to the preceding variant. The device further comprises a pulley or wheel 121 and a cable 24d comprising two strands 24d1 and 24d2. According to FIG. 4D, the pulley 121 is arranged above the screw V and is attached to the actuator frame, the axis of the pulley 121 being substantially parallel to the axis of the actuator. The cable 24dsubstantially travels through the circumference of the pulley 121 and winds in part around the threaded rod or the screw V. The strand of cable 24d1 connecting the distal end of the key return to the pulley 121 by approaching, without touching, the threaded rod or screw V, and the strand of cable 24d2 connecting the pulley 121 to the threaded rod or screw V. The connection point of the distal end of the strand 24d2 is fixed to the periphery of the threaded rod at a point diametrically opposite the connection point of the distal end of the strand of cable 24c2. With reference to FIG. 4D, the connection points are also axially offset. As in the preceding variant, the strands 24c1 and 24c2 are attached to the threaded rod or the screw V on the same side or offset axially along a peripheral line of the screw V.

In operation and when the key is pressed, the strand of cable 24c2 winds around the screw V and the length of the strand decreases, the strand of cable 24d2 is uncoiled from the screw V, the strand of cable 24c1 is uncoiled from the screw V and the length of the strand increases, and the length of the strand of cable 24d1 increases. The two cables 24c and 24d exert a pair of opposing forces on the actuator axis, while adding forces that accumulate on the key return. The function of the cable 24d is to pull on the key like the strand 24c1, but, thanks to the return pulley 121 pulls on the motor in the direction opposite that of the strand 24c1, while rotating the actuator in the same direction.

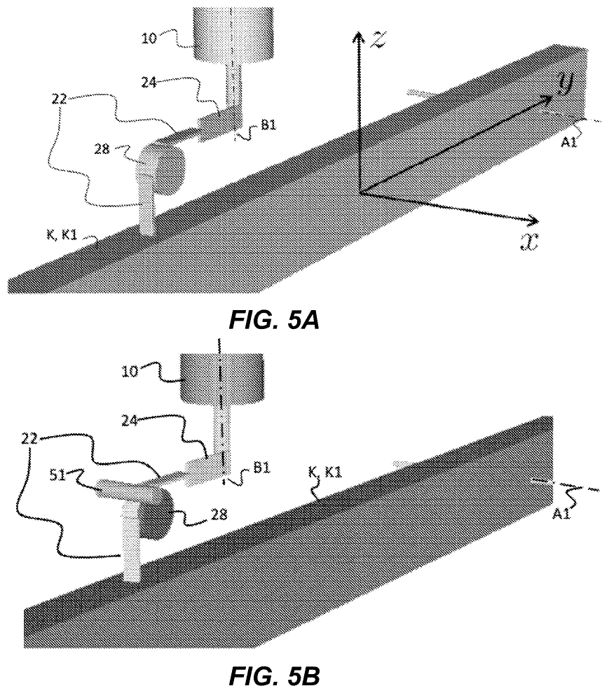

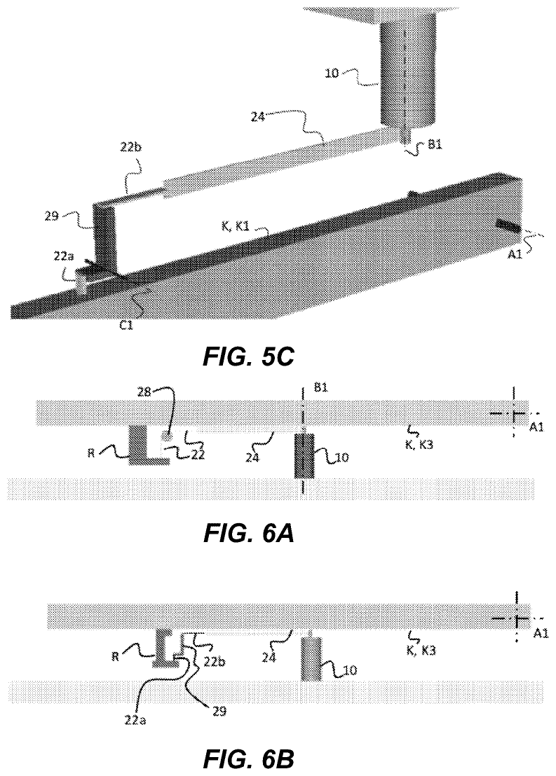

FIG. 5A shows a third embodiment that will be described by its differences relative to the first embodiment. The electric motor 10 is located above the key K and is fixed to the frame (not visible in the figure). The rotation axis B1 of the electric motor is perpendicular to the longitudinal direction of the key K. The actuator ribbon 24 extends horizontally and tangentially to the rotation shaft of the motor. For simplicity's sake, the assembly means, the junction means and the connecting means are not shown here. The mechanical linking means further comprise a pulley 28 whose rotation axis is parallel to the pivot axis A1. The pulley is connected to the frame, not visible in the figure. The pulley makes it possible to receive, over its circumference, the key ribbon 22 along its path. Between the junction piece and the pulley, the part of the key ribbon extends substantially horizontally. Between the pulley and the connecting means, the part of the key ribbon extends substantially vertically. According to an alternative embodiment shown in FIG. 5B, the device further comprises a cylinder-shaped counter-pulley 51 and is arranged tangentially to the pulley 28. The counter-pulley is in contact or quasi-contact with the key ribbon 22. The counter-pulley makes it possible to guide and/or control the movement of the key ribbon and thus to keep the key ribbon on the periphery of the pulley 28. The counter-pulley prevents the key ribbon from detaching from the pulley.

FIG. 5C shows a fourth embodiment that will be described by its differences relative to the preceding embodiment. The mechanical linking means comprise, as a replacement for the pulley 28, a bracket 29 whose rotation axis C1 is parallel to the pivot axis A1. The axis C1 of the bracket is connected to the frame, not visible in the figure. The bracket receives the key ribbon 22 along its path. The key ribbon 22 comprises a first key ribbon 22b and a second key ribbon 22a. Between the junction piece and the bracket, the first key ribbon 22b extends substantially horizontally. Between the bracket and the connecting means, the second key ribbon 22a extends substantially vertically.

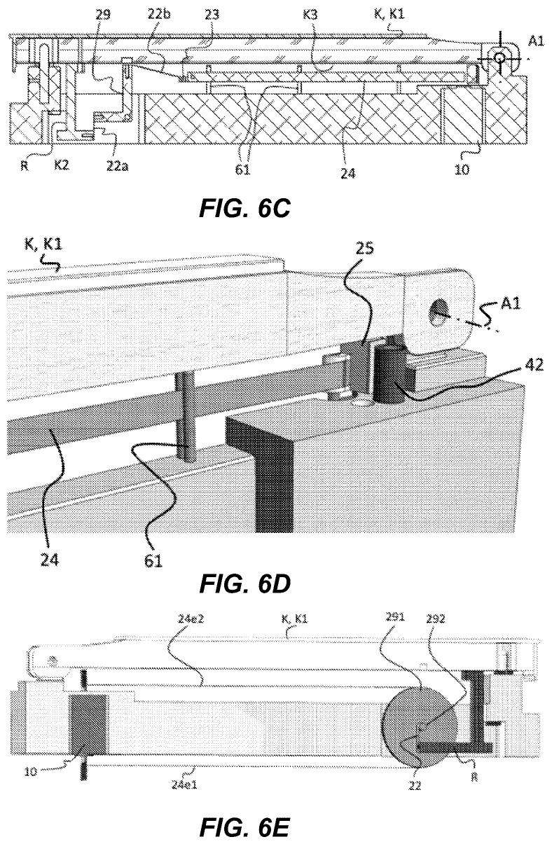

FIG. 6A shows a fifth embodiment that will be described by its differences relative to the third embodiment. The key shown corresponds to a key of a flat piano, the key comprising a key return R, like the second embodiment. The electric motor 10 is located below the key K. The rotation axis B1 of the motor is perpendicular to the longitudinal direction of the key and perpendicular to the pivot axis A1. The mechanical linking means extend under the lower face K3 of the key. The pulley 28 is located between the upper face of the key return R and the lower face K3 of the key. The connecting means, not visible, are attached to the upper face K2 of the key return.

FIG. 6B shows a sixth embodiment that will be described by its differences relative to the preceding embodiment. The pulley 28 is replaced by the bracket 29, the arrangement of which relative to the key and actuator ribbons is similar or identical to the fourth embodiment.

According to an alternative embodiment represented by FIG. 6C, which will be described by its differences relative to the preceding embodiment, the actuator 10 is arranged near the pivot axis A1. The device further comprises one of the ribbon guides 61 making it possible to guide the movement of the actuator ribbon 24. Each ribbon guide comprises a pair of rods spaced apart from each other so that the ribbon can translate between them, see also FIG. 6D.

Referring to FIG. 6D representing an alternative embodiment that can be integrated into all of the preceding embodiments, the mechanical linking means further comprise an actuator stop 42 arranged near the rotation shaft of the actuator so as to restrict the angular travel of the shaft. The stop 42 has a cylindrical shape and is fixed to a frame. The stop 42 is provided to limit the rotation of the rotation shaft of the actuator via the assembly means 25.

According to an alternative embodiment shown in FIG. 6E, the device comprises a wheel 291 and a roller 292 arranged coaxially, the diameter of the wheel 291 being greater than the diameter of the roller, for example, at least three times greater. The wheel 291 and roller 292 assembly is arranged near the key return such that the key ribbon 22 is connected to the roller 292 and the distal end of the key return. Compared to the preceding embodiments, the actuator ribbon 24 is replaced by a cable 24e having two strands 24e1, called the lower strand, and 24e2, called the upper strand. Preferably, the cable 24e is attached to the wheel 291, making it possible, in particular, to limit or prevent the sliding of the cable in contact with the periphery of the wheel.

Furthermore, the actuator 10 is arranged near the pivot axis A1, the rotation axis of the actuator being substantially perpendicular to the pivot axis A1. The actuator comprises two rotation shafts, an upper shaft and a lower shaft, each rotation shaft being arranged at one axial end of the actuator. The cable 24e has one end connected to the upper shaft, extends to the wheel 291 so as to form the upper strand 24e2, travels substantially half the circumference of the wheel 291, extends to the lower shaft so as to form the lower strand 24^{e}<1 and is connected to the lower shaft. One end of 24e1 winds onto the lower part of the axis of the actuator. The ends are wound in different rotary directions: when one end winds, the other unwinds.

In operation when the key is pressed, the key return also descends, the pulling of the key ribbon 22 drives the rotation in the counterclockwise direction of the roller-and-wheel 291 assembly so as to act in traction on the strand of cable 24e1 and unwind the latter from the lower shaft, thus driving the actuator, which exerts a resistive force. This alternative embodiment makes it possible to obtain a very large ratio between the angle of rotation of the actuator and the angle of rotation of the key, this ratio making it possible to accordingly decrease the torque requested from the actuator relative to that to be exerted on the key.

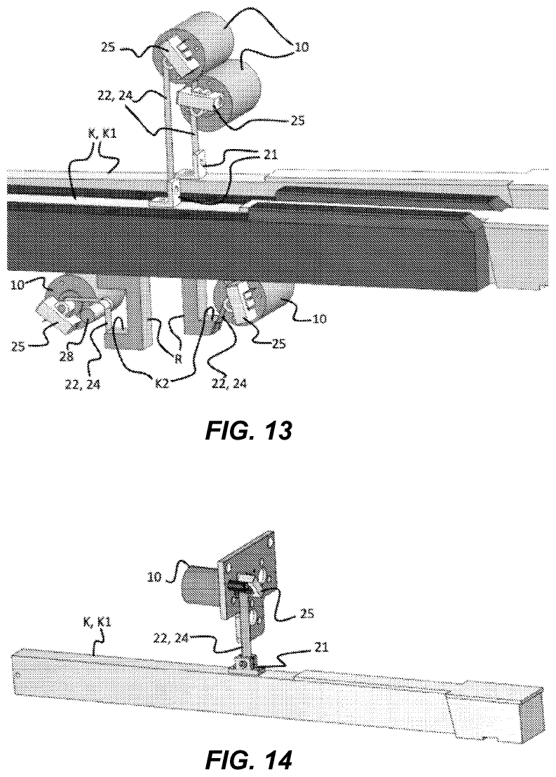

FIG. 12 shows a seventh embodiment that will be described by its differences relative to the first embodiment. The electric motor 10 is located above the upper face K1 of the key, the rotation axis of the motor extending parallel to the pivot axis A1 of the key. The mechanical linking means comprise a single ribbon that performs both the actuator ribbon 24 and the key ribbon 22. The assembly means 25 conform to the assembly means of FIGS. 3A and 3B. The connecting means 21 are in accordance with the connecting means of FIG. 9B. The upper part of FIG. 13 represents two haptic devices according to FIG. 12 and that are connected to white keys. The two actuators associated with the white keys are located above the keys, are superimposed and offset relative to each other.

With reference to the lower part of FIG. 13, an eighth embodiment will be shown that will be described by its differences relative to the previous embodiment. The black keys shown respectively comprise a key return R extending under the key so as to form an “L.” In this case, the rotary electric actuator and the mechanical linking means are located above the upper face K2 of the key return. The keys associated with the black keys are located under the keys and offset from each other. The connecting means are attached to the front face of the end of the key return. The termination of the key ribbon is attached to the distal transverse face of the key return R.

According to an alternative embodiment visible on the lower part of FIG. 13, the mechanical linking means comprise a return pulley 28 arranged between the key return R and the electric motor 10.

The embodiment of FIG. 13 proposes a particular arrangement to solve the problems of bulk posed by the transverse arrangement of actuators, the length of which is several times the average width of the key. The figure shows a perspective view of four keys, three of which are associated with actuators and linking means in configuration AxR1, and the black key of the first plane, with an actuator and linking means in configuration AxR1PxR1. The axes of the actuators are parallel to the rotation axis of the keys and the connecting means are reduced to a single ribbon and its fastening parts.

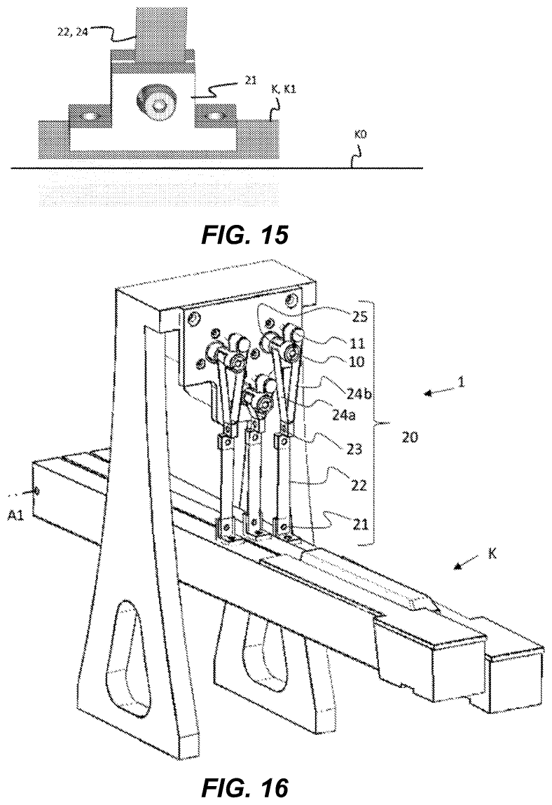

FIG. 14 shows a ninth embodiment that will be described by its differences relative to the first embodiment. The mechanical linking means comprise a single ribbon that performs the function of both the actuator ribbon 24 and the key ribbon 22. The assembly means 25 conform to the assembly means of FIGS. 3A and 3B. The ribbon is connected to the key by specific connecting means 21. Referring to FIG. 15, the connecting means are a connecting part 21 comprising a body from which two parallel plates extend perpendicularly in the longitudinal direction of the key and perpendicular to the pivot axis of the key, the plates being spaced apart from each other so as to define a slot. The slot has a width allowing the insertion of the key termination of the ribbon. The plates respectively have a bore whose axis extends parallel to the pivot axis of the key, the bores being coaxial. In addition, the key termination comprises an opening. The connecting means comprise a connecting shaft arranged to be inserted into the bores and the opening. According to one particular embodiment, each bore has, according to its cross-section, the shape of an oblong hole so that the connecting shaft can translate laterally. Preferably, the longest length of the oblong hole is at least 20% greater than the width (or smallest length) of the oblong hole. The oblong shape of the hole makes it possible to achieve an operating clearance in a direction parallel to the longitudinal direction of the key.

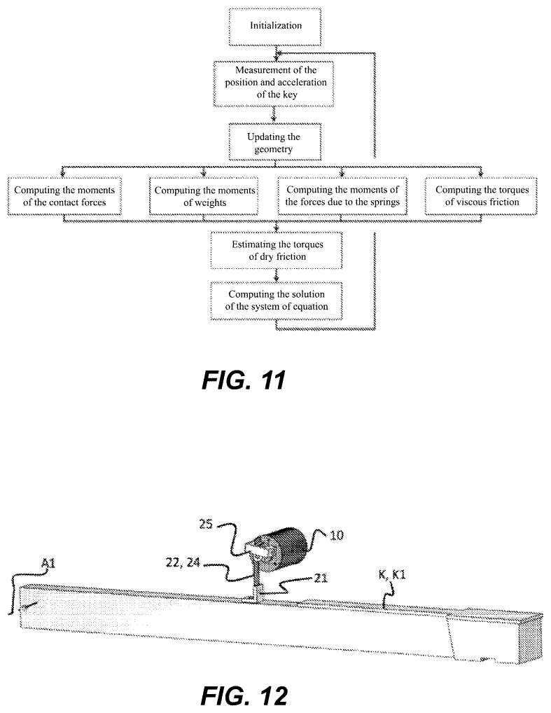

Referring to FIG. 11, the method for computing the retention forces of a traditional or acoustic instrument is illustrated in order to simulate the dynamics thereof.

The various phases of the simulation are described below:
initialization: preliminary step wherein the geometry and the coefficients of the system are initiated;
measurement: the measurements of the position and of the acceleration of the key are collected at the current instant; a filter being applied to reduce the measurement noise; the speed of the key is computed;
updating the geometry: the position of the elements of the system is updated with the measurement of the current instant and the result of the resolution of the equations at the preceding instant;
computing the moments of the forces, the moments of the contact forces, the weights, the forces due to the springs and the torques of viscous friction are computed in parallel;
estimating the torques of dry friction in the articulations and at the contacts between the pieces: this calculation requires everything that is described above in order to be completed properly;
computing the solution of each of the systems of equations that represent on the one hand the dynamics of the mechanical system that it is sought to emulate (an acoustic or other instrument keyboard), and on the other hand, the dynamic of the haptic interface that has been adopted, in the absence of electrical control.

The present disclosure is described in the foregoing by way of example. It is understood that a person skilled in the art is able to produce different variant embodiments of the present disclosure without departing from the scope of the invention as defined by the following claims.

1. A haptic control device for a key of a keyboard equipping an electronic musical instrument for reproducing the sensation of use of a similar acoustic musical instrument, the device being configured to be associated with a key of the electronic musical instrument and pivotably mounted relative to a frame around a pivot axis, the key extending in a longitudinal direction and having an angular travel between a high angular original position and a low angular stop position wherein the device comprises:
detection means for detecting information of a dynamic state of the key;
computing means for computing, as a function of detected information of the dynamic state of the key, an instantaneous resistive force to be exerted on the key in response to the key being depressed;
a rotary electrical actuator arranged to produce the resisting force; and
mechanical linking means arranged between the rotary electrical actuator and the key in order to apply to the key the resisting force, the mechanical linking means comprising at least one element that flexes under pressure and stiffens under traction.

2. The device of claim 1, wherein the rotary electrical actuator has a rotation axis parallel to the pivot axis of the key.

3. The device of claim 1, wherein the rotary electrical actuator has a rotation axis parallel to the longitudinal direction of the key.

4. The device of claim 1, wherein the rotary electrical actuator has a rotation axis perpendicular to the longitudinal direction of the key and to the rotation axis of the key.

5. The device of claim 1, wherein the key end is attached to an upper or lower face of the key.

6. The device of claim 1, wherein the mechanical linking means comprises a key termination that is attached to an upper face of a key return of the key.

7. The device of claim 1, wherein the mechanical linking means comprises an actuator termination and a key termination, the key termination being attached to the key, wherein a ratio between:
a lever arm distance separating the pivot axis from a key point where the key termination of the mechanical linking means is attached to the key, and
a lever arm distance separating the rotation axis of the rotary electrical actuator from an actuator point, where the actuator termination of the mechanical linking means is attached to the actuator shaft, is at least 10.

8. The device of claim 1, wherein the mechanical linking means comprises at least two ribbons that flex under pressure and stiffen under traction.

9. The device of claim 1, wherein the mechanical linking means comprises at least two cables that flex under pressure and stiffen under traction.

10. The device of claim 1, wherein the mechanical linking means comprises at least one ribbon that flexes under pressure and stiffens under traction and at least one cable that flexes under pressure and stiffens under traction.

11. The device of claim 1, wherein the mechanical linking means comprises at least three ribbons that flex under pressure and stiffen under traction.

12. The device of claim 1, wherein the at least one element that flexes under pressure and stiffens under traction is a cable that flexes under pressure and stiffens under traction or a ribbon that flexes under pressure and stiffens under traction.

13. The device of claim 1, wherein the mechanical linking means comprises at least two flexible elements comprising at least two ribbons that flex under pressure and stiffen under traction, and a junction piece arranged between the two ribbons, the junction piece having two opposite and perpendicular ribbon-receiving planes relative to each other to receive the terminations of the two ribbons.

14. The device of claim 1, wherein the mechanical linking means comprises_three flexible elements, two flexible actuator elements arranged to be connected to the actuator shaft, and a flexible key element arranged to be connected to the key, and a junction piece arranged between the key element and the two flexible actuator elements, the junction piece being arranged to receive the terminations of the three ribbons.

15. The device of claim 1, wherein the mechanical linking means comprises at least two flexible elements, a flexible actuator element arranged to be connected to the actuator shaft and a flexible key element arranged to be connected to the key, and a return part having a pivot axis, the return part being arranged between two flexible elements, the return part being arranged to produce a non-rectilinear trajectory of the mechanical linking means.

16. The device of claim 1, wherein the mechanical linking means comprises three ribbons, an actuator ribbon arranged to be connected to the actuator shaft, a first key ribbon, a junction piece arranged between the actuator ribbon and the first key ribbon, a second key ribbon arranged to be connected to the key, and a return component arranged between the first key ribbon and the second key ribbon and configured to receive the terminations of the ribbons extending orthogonally.

17. The device of claim 15, wherein the return part is an “L”-shaped levered actuation part or a pulley.

18. The device of claim 1, further comprising an actuator stop arranged at the periphery of the rotation shaft of the actuator or around the rotation shaft, so as to control the angular travel of the rotation shaft of the actuator.

19. The device of claim 1, wherein the computing means comprises an actuator module integrating a mechanical model for controlling at least one key of at least one acoustic musical instrument.

20. The device of claim 1, wherein the computing means comprises four-quadrant control means for actuating the electrical actuator.

21. An electronic musical instrument keyboard with haptic feedback comprising at least one key and at least one haptic control device according to claim 1, each key being associated with a haptic control device.

22. An electronic musical instrument comprising at least one haptic device according to claim 1.

23. A method for controlling an electronic musical instrument comprising at least one haptic control device according to claim 1, the method comprising:
detecting a user pressing the key, by the detection means,
controlling in real-time the actuator to exert a tensile force on the key so as to resist a pressing force, or to exert a tensile force so as to return the key into its original position.

24. The control method of claim 23, wherein the detection means periodically measures a position and/or an acceleration of the key to obtain measurements and then transmits information corresponding to the measurements to the computing means, the computing means computing forces generated in a real instrument mechanism from a mathematical model of dynamics of the mechanism.
